(19) United States
(12) Patent Application Publication
(10) Pub. No.: US 2026/0077510 A1
(43) Pub. Date: Mar. 19, 2026

(54) SYSTEMS AND METHODS TO PERFORM ROBOTIC WELDING PATH CORRECTION

(71) Applicant: Illinois Tool Works Inc., Glenview, IL (US)

(72) Inventors: Samantha Noland, Roselle, IL (US); John William Smith, Glendale Heights, IL (US); Kevin Gregory Pagano, Algonquin, IL (US); Jeremy Danel Overesch, Neenah, WI (US); Dorothy Shamonsky, Lincoln, MA (US); Michael Kannemeyer, Somerville, MA (US); Praveen Dandu, Green Bay, WI (US)

(21) Appl. No.: 19/329,874

(22) Filed: Sep. 16, 2025

Related U.S. Application Data
(60) Provisional application No. 63/695,630, filed on Sep. 17, 2024.

(51) Int. Cl. B25J 11/00; B23K 9/095; B25J 9/16; B25J 13/08

(52) U.S. Cl. CPC B25J 11/005; B23K 9/0956; B25J 9/1664; B25J 9/1669; B25J 13/088

(57) ABSTRACT

Disclosed example robotic welding systems include: a welding-type power supply configured to output welding-type power to a welding-type torch; a robotic manipulator configured to manipulate the welding-type torch; and robot control circuitry configured to: load a welding program comprising a sequence of robotic welding instructions, the robotic welding instructions comprising a plurality of positions associated with a welding operation to be performed along a welding seam using the welding-type torch, the sequence further comprising a position correction instruction; in response to reaching the position correction instruction in the sequence: automatically control the robotic manipulator to move the welding-type torch to detect positions of one or more surfaces associated with the weld seam; and based on the detected positions of the one or more surfaces associated with the weld seam, applying a correction to ones of the positions associated with the position correction instruction; and perform the robotic welding instructions in the sequence based on the plurality of positions and based on the corrections.

### RELATED APPLICATIONS

The present application claims the benefit of U.S. Provisional Patent Application Ser. No. 63/695,630, filed Sep. 17, 2024, entitled “SYSTEMS AND METHODS TO PERFORM ROBOTIC WELDING PATH CORRECTION.” The entirety of U.S. Provisional Patent Application Ser. No. 63/695,630 is expressly incorporated herein by reference.

### FIELD OF THE DISCLOSURE

This disclosure relates generally to robotic welding and, more particularly, to systems and methods to perform robotic welding path correction.

### BACKGROUND

Robotic welding is often used to perform repetitive welding operations involving workpieces having a consistent configuration and series of welds to be performed. However, programming robots to perform the welding can be a difficult, tedious, and error-prone task.

### SUMMARY

Systems and methods to perform robotic welding path correction are disclosed, substantially as illustrated by and described in connection with at least one of the figures, as set forth more completely in the claims.

### BRIEF DESCRIPTION OF THE DRAWINGS

FIG. 1 illustrates an example robotic welding system to perform welding, including a welding-type power supply and a robot controller, in accordance with aspects of this disclosure.

FIG. 2 is a block diagram of an example implementation of the welding-type power supply and the robot control system of FIG. 1.

FIG. 3 is a block diagram of another example implementation of the welding-type power supply and the robot control system of FIG. 1.

FIG. 4 illustrates an operator interface which may be used to generate instructions to perform robotic welding path correction.

FIG. 5 illustrates an example workpiece and welding torch held by the robotic manipulator of FIG. 1, during a touch-sensing search procedure to perform a position correction instruction.

FIG. 6 illustrates the example user interface of FIG. 4, in which a non-groove type of joint is selected via the groove joint selection input.

FIGS. 7A and 7B illustrates another example workpiece and welding torch held by the robotic manipulator of FIG. 1, during a touch-sensing search procedure to perform a position correction instruction.

FIG. 8 illustrates another example operator interface which may be used to associate robotic welding instructions with position correction instructions.

FIG. 9 is a flowchart representative of example method which may be performed by the example robotic welding system of FIG. 1 to perform a robotic welding procedure with welding path correction.

FIG. 10 is a flowchart representative of example machine readable instructions which may be executed by the example robot controller to generate a robotic welding program.

FIG. 11 is a flowchart representative of example machine readable instructions which may be performed to implement the robot controller of FIGS. 1, 2, and/or 3 to apply touch sensing procedure(s) to robotic welding instructions to generate position correction instruction(s).

FIG. 12 is a flowchart representative of example machine readable instructions which may be performed to implement the robot controller of FIGS. 1, 2, and/or 3 to perform a robotic welding program using the robotic welding system to weld a part.

The figures are not necessarily to scale. Where appropriate, similar or identical reference numbers are used to refer to similar or identical components.

### DETAILED DESCRIPTION

For the purpose of promoting an understanding of the principles of this disclosure, reference will be now made to the examples illustrated in the drawings and specific language will be used to describe the same. It will nevertheless be understood that no limitation of the scope of the claims is intended by this disclosure. Modifications in the illustrated examples and such further applications of the principles of this disclosure as illustrated therein are contemplated as would typically occur to one skilled in the art to which this disclosure relates.

The demand for skilled welders has been significantly higher than the supply of available welders in recent years. To partially alleviate this condition, both collaborative robots (“cobots”) and industrial robots (non-collaborative robots) are becoming more widely used for welding. However, programming of industrial robots can require significant training and involve substantial time per welding program, such that the quantity of repetitive parts to justify generating a welding program on an industrial robot can be relatively high. Collaborative robots have been introduced into the welding industry to provide a robotic solution that is capable of consistent welding results, similar to industrial robots, but with the ability to be more easily programmed by an operator to perform welding by allowing for direct operator manipulation of the robot.

Additionally, robotic welding generally relies on a consistent location of the welding path to perform acceptable welds according to a welding program. However, part fit up and fixturing may be subject to tolerances that are greater than the acceptable deviation from the programmed welding path.

Disclosed example systems and methods allow for significantly easier programming of robotic welding systems to perform touch-based searching of a welding seam. In some examples, disclosed systems and methods include an operator interface having a display and one or more input devices, which may be operated by a user to define touch-based searching as part of welding sequence, and apply the touch-based searching to desired welds within the welding sequence. In some such examples, the operator input device allows the operator to define an approach point, such as by manually guiding the welding-type torch, and easily generate an instruction to perform the touch-based searching.

Disclosed example robotic welding systems include: a welding-type power supply configured to output welding-type power to a welding-type torch; a robotic manipulator configured to manipulate the welding-type torch; and robot control circuitry configured to: load a welding program comprising a sequence of robotic welding instructions, the robotic welding instructions comprising a plurality of positions associated with a welding operation to be performed along a welding seam using the welding-type torch, the sequence further comprising a position correction instruction; in response to reaching the position correction instruction in the sequence: automatically control the robotic manipulator to move the welding-type torch to detect positions of one or more surfaces associated with the weld seam; and based on the detected positions of the one or more surfaces associated with the weld seam, applying a correction to ones of the positions associated with the position correction instruction; and perform the robotic welding instructions in the sequence based on the plurality of positions and based on the corrections.

Some example robotic welding systems further include touch detection circuitry coupled to the welding-type torch and configured to detect contact between a welding wire fed via the welding-type torch and a workpiece, in which the robot control circuity is configured to detect the positions of the one or more surfaces based on the touch detection circuitry detecting the contact between the welding wire and the workpiece. Some example robotic welding systems further include a user interface having a display and an input device, in which the input device is configured to receive a type of weld joint from a plurality of types of weld joints, and the robot control circuitry is further configured to control the robotic manipulator to move the welding-type torch to detect the positions of the one or more surfaces based on the type of weld joint.

In some example robotic welding systems, the user interface is configured to receive a user selection of one or more of the predetermined coordinate directions, the robot control circuitry configured to control the robotic manipulator to move the welding-type torch along the selected one or more of the predetermined coordinate directions. In some example robotic welding systems, the user interface is configured to limit the predetermined coordinate directions based on the type of weld joint.

In some example robotic welding systems, the robot control circuitry is further configured to control the robotic manipulator to move the welding-type torch along one or more of a plurality of predetermined coordinate directions to detect the positions of the one or more surfaces. In some example robotic welding systems, the position correction instructions include an approach point, wherein the robot control circuitry is configured to control the robotic manipulator to move the welding-type torch to the approach point to begin detecting the positions of the one or more surfaces. In some example robotic welding systems, the user interface is configured to receive an input to set a position of the approach point.

In some example robotic welding systems, the robot control circuitry is configured to, based on determining that the weld joint type is a groove joint, control the robotic manipulator to: move the welding-type torch to an approach point defined by the position correction instruction; move the welding-type torch in a first predetermined direction; in response to detecting a first contact between the welding-type torch and the workpiece, store the position of the welding-type torch as a first position and stop movement of the welding-type torch; move the welding-type torch in a second direction; in response to detecting a second contact between the welding-type torch and the workpiece, store the position of the welding-type torch as a second position and stop movement of the welding-type torch; determine a root position along the second direction based on the first position and the second position; move the welding-type torch in a third predetermined direction, opposite the second predetermined direction, based on the root position; and move the welding-type torch in the first predetermined direction; and in response to detecting a third contact between the welding-type torch and the workpiece, store the position of the welding-type torch as a third position and stop movement of the welding-type torch. In some example robotic welding systems, the user interface is configured to receive an input to select the second direction.

In some example robotic welding systems, the robot control circuitry is configured to, in response to determining that the weld joint type is a fillet joint or other non-groove joint, control the robotic manipulator to: move the welding-type torch to an approach point defined by the position correction instruction; move the welding-type torch in a first direction; in response to detecting a first contact between the welding-type torch and the workpiece, store the position of the welding-type torch as a first position and stop movement of the welding-type torch; and determine a weld seam position based on the first position.

In some example robotic welding systems, the robot control circuitry is further configured to, in response to determining that the weld joint type is a fillet joint or other non-groove joint, control the robotic manipulator to: move the welding-type torch in a second direction; in response to detecting a second contact between the welding-type torch and the workpiece, store the position of the welding-type torch as a second position and stop movement of the welding-type torch; and determine the weld seam position based on the first position and the second position.

In some example robotic welding systems, the robot control circuitry is further configured to, in response to determining that the weld joint type is a fillet joint or other non-groove joint, control the robotic manipulator to: move the welding-type torch in a third direction, different than the first direction and the second direction; and in response to detecting a third contact between the welding-type torch and the workpiece, store the position of the welding-type torch as a third position and stop movement of the welding-type torch; and determine the weld seam position based on the first position, the second position, and the third position. In some example robotic welding systems, the robot control circuitry is configured to control the robotic manipulator to move to a second approach point prior to moving the welding-type torch in the third direction. In some example robotic welding systems, the user interface is configured to receive a position of the second approach point as an input.

In some example robotic welding systems, the user interface is configured to receive a selection of the first direction and the second direction. Some example robotic welding systems further include a user interface having a display and an input device, the robot control circuitry configured to associate the ones of the positions with the position correction instruction and apply the correction based on the associated ones of the positions.

As used herein, a “collaborative robot welding system” refers to a robotic welding system which is configured to be programmed or taught using lead-through teaching, in which an operator may physically grasp and manipulate the robot during programming.

As used herein, the word “exemplary” means “serving as an example, instance, or illustration.” The examples described herein are not limiting, but rather are exemplary only. It should be understood that the described examples are not necessarily to be construed as preferred or advantageous over other examples. Moreover, the terms “examples of the invention,” “examples,” or “invention” do not require that all examples of the invention include the discussed feature, advantage, or mode of operation.

As utilized herein the terms “circuits” and “circuitry” refer to physical electronic components (i.e. hardware) and any software and/or firmware (code) that may configure the hardware, be executed by the hardware, and/or otherwise be associated with the hardware. As used herein, for example, a particular processor and memory may comprise a first “circuit” when executing a first set of one or more lines of code and may comprise a second “circuit” when executing a second set of one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y and z”. As utilized herein, the term “exemplary” means serving as a non-limiting example, instance, or illustration. As utilized herein, the terms “e.g.” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by an operator-configurable setting, factory trim, etc.).

As used herein, a welding-type power source refers to any device capable of, when power is applied thereto, supplying welding, cladding, plasma cutting, induction heating, laser (including laser welding and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

Some disclosed examples describe electric currents being conducted “from” and/or “to” locations in circuits and/or power supplies. Similarly, some disclosed examples describe “providing” electric current via one or more paths, which may include one or more conductive or partially conductive elements. The terms “from,” “to,” and “providing,” as used to describe conduction of electric current, do not necessitate the direction or polarity of the current. Instead, these electric currents may be conducted in either direction or have either polarity for a given circuit, even if an example current polarity or direction is provided or illustrated.

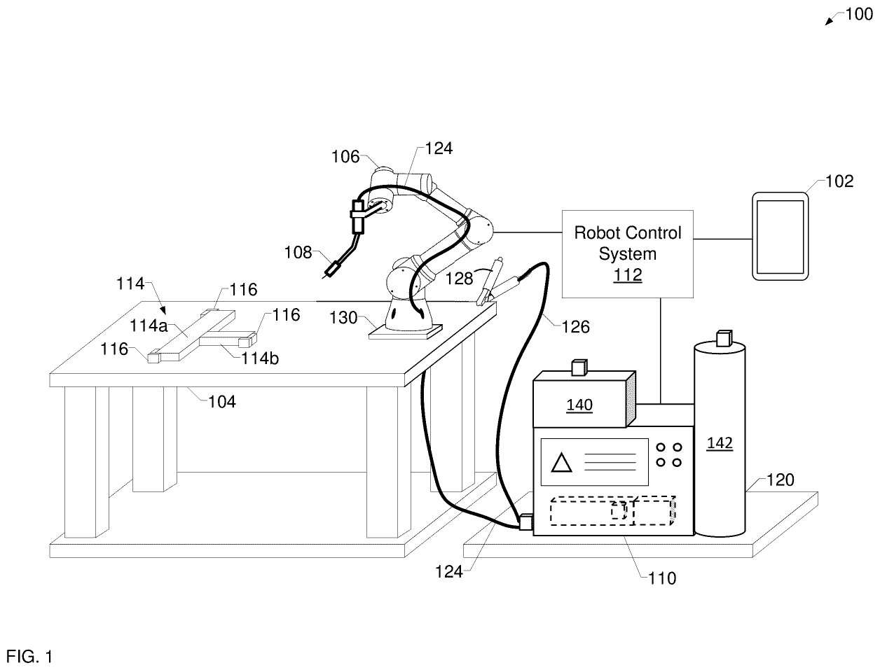

FIG. 1 illustrates an example robotic welding system 100 to generate welding programs. The example robotic welding system 100 of FIG. 1 includes a welding table 104, a collaborative robotic manipulator 106 configured to manipulate a welding torch 108, a welding-type power supply 110, and a robot controller 112. The example robotic welding system 100 is usable by an operator to easily create welding programs for a particular part, at least in part by allowing the operator to perform lead-through teaching. In some examples, the lead-through teaching may be supplemented by an operator interface 102, such as a pendant or other computing device, to allow the operator a high degree of control over generating the welding program. As part of or in addition to creating a weld program, the robotic welding system 100 may also execute welding programs, with and/or without welding power provided to the welding torch.

The welding table 104, robotic manipulator 106, the welding torch 108, the welding-type power supply 110, and/or the robot controller 112, and/or subgroups of these components, may be packaged together (e.g., pre-assembled, pre-calibrated) to provide rapid setup of the robotic welding system 100 for welding at the end-user location. In the example of FIG. 1, the robotic manipulator 106 and/or the robot controller 112 are configured as a collaborative robot, which provides features that make the robotic manipulator 106 more conducive to working in areas in which people are proximate the robotic welding system 100.

In the example of FIG. 1, a workpiece 114 is positioned on the welding table 104. The workpiece 114 may include multiple components 114a, 114b which are to be welded together at one or more joints. To provide consistency in arrangement of the workpiece components 114a, 114b, the robotic welding system 100 may further include fixtures 116 attached to the welding table 104. The fixtures 116 may guide the placement of the components 114a, 114b, which can be used to consistently place the multiple components 114a, 114b.

During a welding operation or welding procedure (e.g., testing a generated welding program), the robotic welding system 100 manipulates the welding torch 108, such as the illustrated welding torch, to which power is delivered by the welding-type power supply 110 via a first conductor 124 and returned by way of a work cable 126 and a work clamp 128 coupled to the work table 104. The welding equipment may further include, for example, a source of shielding gas 142, a wire feeder 140, and other accessories and/or equipment. Other accessories and/or equipment may include, for example, water coolers, fume extraction devices, one or more controllers, sensors, user interfaces, and/or communication devices (wired and/or wireless).

The example robotic welding system 100 is configured to form a weld using any known electric welding techniques. Example electric welding techniques include shielded metal arc welding (SMAW), MIG, flux-cored arc welding (FCAW), TIG, laser welding, sub-arc welding (SAW), stud welding, friction stir welding, and resistance welding. In some examples, the welding-type power supply 110 and/or other welding equipment are configured to support one or more, but fewer than all, types of welding processes. To change welding processes, the welding-type power supply 110, torch 108, and/or other welding equipment may be removed (e.g., disconnected and moved away from the robotic welding system 100) and replaced by a different welding-type power supply, torch, and/or other welding equipment that supports the desired welding process. To facilitate ease of movement, the example welding equipment may be mounted or attached to a cart 120 or other conveyance (e.g., ground conveyance, hanging conveyance, etc.). Additionally or alternatively, multiple different types of welding equipment (e.g., multiple power supplies having different capabilities, multiple torches, etc.) may be co-located (e.g., proximate to a same robotic manipulator 106, on a rack of equipment, etc.) to enable rapid reconfiguration of the robotic welding system 100.

The example robotic manipulator 106 may operate using any number of degrees of freedom to manipulate the welding torch 108. For example, the robotic manipulator 106 may include multiple joints, in which each joint has one or more degrees of freedom, to achieve multiple orientations for accessing one or more weld joints on the workpiece 114. Whereas conventional welding robots are contained within a weld cell that is protected against intrusion by operators during robot operations (e.g., welding operations and/or other movement by the robot), in some examples the robotic welding system 100 is configured as a cobot, has a controller or processor, as well as one or more sensors, that are configured to operate in a manner such that humans do not necessarily need to be excluded from the area in which the robotic manipulator 106 is operating. For example, the robotic manipulator 106 may rapidly detect and respond to collisions, may operate with reduced speed and/or joint torque relative to conventional welding robots, and/or implement other features.

The robotic manipulator 106 is coupled to the table 104 via a base 130. Once secured, the base 130 is fixed with respect to the table 104, and may serve as a reference for position and/or orientation for the robotic manipulator 106.

The example robotic manipulator 106 and/or the example robot controller 112 are configured to transmit commands, requests, data, and/or other messages and/or communications to the power supply 110 via one or more protocols. The robotic manipulator 106 and/or the robot controller 112 are further configured to receive responses, acknowledgments, data, and/or other messages and/or communications from the power supply 110 via the one or more protocols. Based on a robotic welding procedure, the robotic manipulator 106 and/or the robot controller 112 may communicate parameters to the power supply 110 for configuration according to the robotic welding procedure, and/or adjust the welding-type process based on the variables and/or other data obtained from the power supply 110 while performing welding operations. In addition to communication with the power supply 110, the robotic manipulator 106, and/or the robot controller 112, the power supply 110, the robotic manipulator 106, and/or the robot controller 112 may communicate with other welding equipment (e.g., a welding accessory, such as the wire feeder 140) and/or other robotic equipment.

Example power source input parameters that may be transmitted by the robotic manipulator 106 and/or the robot controller 112 to the power supply 110 (e.g., directly, via a network, via a communications bus, etc.) include: a trigger command (e.g., to command the power supply 110 whether to output welding-type power and, when a wire-fed process is used, to command the power supply 110 or a separate wire feeder to feed wire); a purge command (e.g., to command the power supply 110 whether to output shielding gas); a jog command (e.g., to command the power supply 110 or a separate wire feeder whether to feed wire without outputting welding-type power); a schedule parameter (e.g., to select one of one or more previously defined sets of welding parameters); a wire speed parameter (e.g., to cause the power supply 110 or a wire feeder to control wire feeding to a specified rate); a voltage parameter (e.g., to cause the power supply 110 to output the welding-type power using a specified target voltage); an arc length parameter (e.g., to cause the power supply 110 to output the welding-type power based on a specified arc length); a current parameter (e.g., to cause the power supply 110 to output the welding-type power based on a specified target current); an electrode type parameter (e.g., to cause the power supply 110 to configure one or more welding parameters based on a specified electrode type); an electrode diameter parameter (e.g., to cause the power supply 110 to configure one or more welding parameters based on a specified electrode diameter); a gas type parameter (e.g., to cause the power supply 110 to configure one or more welding parameters based on a specified gas type); a material thickness parameter (e.g., to cause the power supply 110 to configure one or more welding parameters based on a specified material thickness of a workpiece); a process parameter (e.g., to cause the power supply 110 to output the welding-type power based on a specified welding-type process, such as pulse, short arc MIG, TIG, stick, etc.); a pulses per second parameter (e.g., to cause the power supply 110 to output the welding-type power based on a specified number of pulses per second in a pulse process); and/or an arc control parameter (e.g., to cause the power supply 110 to output the welding-type power based on a specified arc control, or simulated inductance, parameter). However, different welding-type power supplies may support or lack support for different combinations of these input parameters.

Example power source output parameters that may be transmitted by the power supply 110 the robotic manipulator 106 and/or the robot controller 112 (e.g., directly, via a network, via a communications bus, etc., asymmetrically and/or in response to a request) include: an output indicator (e.g., an indication of whether the power supply 110 is currently outputting welding-type current, an indication of whether the power supply 110 has an active welding-type output, etc.); a current detection indicator (e.g., an indication of whether a current output is currently detected by the power supply 110); a touch detection indicator (e.g., an indication of whether a short circuit is currently measured or detected by the power supply 110); a gas on indicator (e.g., an indication of whether the power supply 110 is currently outputting shielding gas and/or controlling a gas valve to output shielding gas); a ready indicator (e.g., an indication of whether the power supply 110 is in a state in which a welding-type operation could be performed, an indication of whether the power supply 110 is in an error or other state in which a welding-type operation could not be performed, an indication of whether the power supply 110 will respond to a trigger command, etc.); an error indicator (e.g., an indication of whether the power supply 110 is in an error state); a voltage feedback variable (e.g., a measured voltage feedback currently output by the power supply 110, such as the measured instantaneous voltage, the measured average voltage, the measured RMS voltage, etc.); a current feedback variable (e.g., a measured current feedback currently output by the power supply 110, such as the measured instantaneous current, the measured average current, the measured RMS current, etc.); a wire feed speed setpoint variable (e.g., a wire feed speed setpoint with which the power supply 110 or other wire feeder is currently configured); a voltage setpoint variable (e.g., a welding-type voltage setpoint with which the power supply 110 is currently configured, a control loop target voltage, etc.); a current setpoint variable (e.g., a welding-type current setpoint with which the power supply 110 is currently configured, a control loop target current, etc.); and/or an arc length setpoint variable (e.g., an arc length setpoint with which the power supply 110 is currently configured, a control loop arc length target, etc.). However, different welding-type power supplies may support or lack support for different combinations of these output parameters.

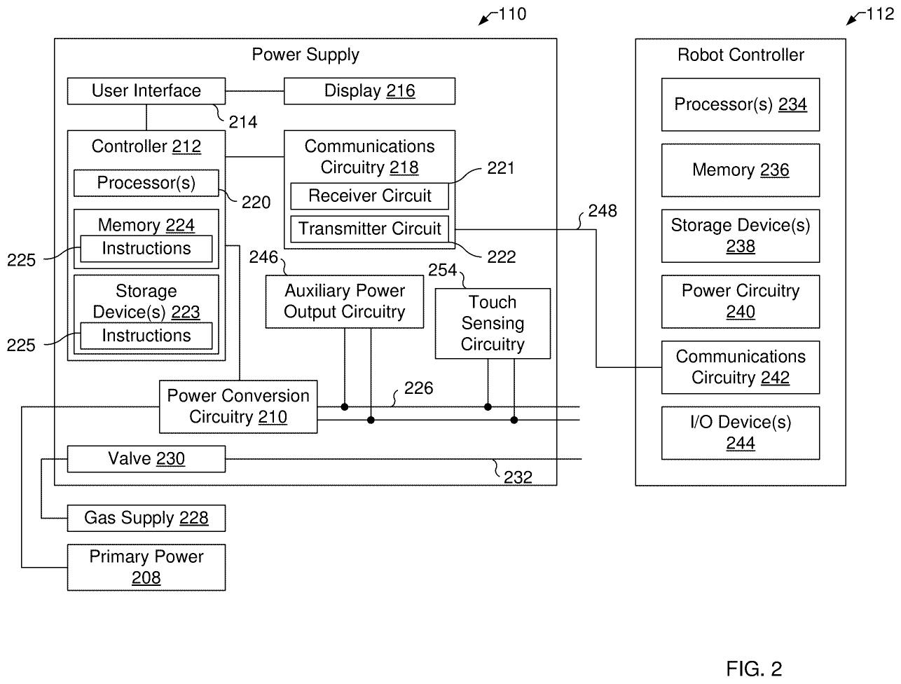

FIG. 2 is a block diagram of an example implementation of the welding-type power supply 110 and the robot controller 112 of the robotic welding system 100 of FIG. 1. The example welding-type power supply 110 powers, controls, and supplies consumables to a welding application. In some examples, the welding-type power supply 110 directly supplies input power to the welding torch 108. In the illustrated example, the welding-type power supply 110 is configured to supply power to welding operations and/or preheating operations. The example welding-type power supply 110 may also provide power to a wire feeder to supply electrode wire to the welding torch 108 for various welding applications (e.g., GMAW welding, flux core arc welding (FCAW)).

The welding-type power supply 110 receives primary power 208 (e.g., from the AC power grid, an engine/generator set, a battery, or other energy generating or storage devices, or a combination thereof), conditions the primary power, and provides an output power to one or more welding devices and/or preheating devices in accordance with demands of the system. The primary power 208 may be supplied from an offsite location (e.g., the primary power may originate from the power grid). The welding-type power supply 110 includes a power conversion circuitry 210, which may include transformers, rectifiers, switches, and so forth, capable of converting the AC input power to AC and/or DC output power as dictated by the demands of the system (e.g., particular welding processes and regimes). The power conversion circuitry 210 converts input power (e.g., the primary power 208) to welding-type power based on a weld voltage setpoint and outputs the welding-type power via a weld circuit.

In some examples, the power conversion circuitry 210 is configured to convert the primary power 208 to both welding-type power and auxiliary power outputs. However, in other examples, the power conversion circuitry 210 is adapted to convert primary power only to a weld power output, and a separate auxiliary converter is provided to convert primary power to auxiliary power. In some other examples, the welding-type power supply 110 receives a converted auxiliary power output directly from a wall outlet. Any suitable power conversion system or mechanism may be employed by the welding-type power supply 110 to generate and supply both weld and auxiliary power.

The welding-type power supply 110 includes a controller 212 to control the operation of the welding-type power supply 110. The welding-type power supply 110 also includes a user interface 214. The controller 212 receives input from the user interface 214, through which a user may choose a process and/or input desired parameters (e.g., voltages, currents, particular pulsed or non-pulsed welding regimes, and so forth). The user interface 214 may receive inputs using any input device, such as via a keypad, keyboard, buttons, touch screen, voice activation system, wireless device, etc. Furthermore, the controller 212 controls operating parameters based on input by the user as well as based on other current operating parameters. Specifically, the user interface 214 may include a display 216 for presenting, showing, or indicating, information to an operator. The controller 212 may also include interface circuitry for communicating data to other devices in the system, such as the wire feeder, the robotic manipulator 106, and/or the robot controller 112. For example, in some situations, welding-type power supply 110 wirelessly communicates with other welding devices within the welding system. Further, in some situations, the welding-type power supply 110 communicates with other welding devices using a wired connection, such as by using a network interface controller (NIC) to communicate data via a network (e.g., ETHERNET, 10baseT, 10base100, etc.).

The controller 212 includes at least one controller or processor 220 that controls the operations of the welding-type power supply 110. The controller 212 receives and processes multiple inputs associated with the performance and demands of the system. The processor 220 may include one or more microprocessors, such as one or more “general-purpose” microprocessors, one or more special-purpose microprocessors and/or ASICS, and/or any other type of processing device. For example, the processor 220 may include one or more digital signal processors (DSPs).

The example controller 212 includes one or more storage device(s) 223 and one or more memory device(s) 224. The storage device(s) 223 (e.g., nonvolatile storage) may include ROM, flash memory, a hard drive, and/or any other suitable optical, magnetic, and/or solid-state storage medium, and/or a combination thereof. The storage device 223 stores data (e.g., data corresponding to a welding application), instructions (e.g., software or firmware to perform welding processes), and/or any other appropriate data. Examples of stored data for a welding application include an attitude (e.g., orientation) of a welding torch, a distance between the contact tip and a workpiece, a voltage, a current, welding device settings, and so forth.

The memory device 224 may include a volatile memory, such as random access memory (RAM), and/or a nonvolatile memory, such as read-only memory (ROM). The memory device 224 and/or the storage device(s) 223 may store a variety of information and may be used for various purposes. For example, the memory device 224 and/or the storage device(s) 223 may store processor executable instructions 225 (e.g., firmware or software) for the processor 220 to execute. In addition, one or more control regimes for various welding processes, along with associated settings and parameters, may be stored in the storage device 223 and/or memory device 224, along with code configured to provide a specific output (e.g., initiate wire feed, enable gas flow, capture welding current data, detect short circuit parameters, determine amount of spatter) during operation.

In some examples, the welding power flows from the power conversion circuitry 210 through a weld cable 226. The example weld cable 226 is attachable and detachable from weld studs at each of the welding-type power supply 110 (e.g., to enable ease of replacement of the weld cable 226 in case of wear or damage). Furthermore, in some examples, welding data is provided with the weld cable 226 such that welding power and weld data are provided and transmitted together over the weld cable 226.

In some examples, the welding-type power supply 110 includes or is implemented in a wire feeder.

The example communications circuitry 218 includes a receiver circuit 221 and a transmitter circuit 222. Generally, the receiver circuit 221 receives data transmitted by the robotic manipulator 106 and/or the robot controller 112, and the transmitter circuit 222 transmits data to the robotic manipulator 106 and/or the robot controller 112.

In some examples, a gas supply 228 provides shielding gases, such as argon, helium, carbon dioxide, and so forth, depending upon the welding application. The shielding gas flows to a valve 230, which controls the flow of gas, and if desired, may be selected to allow for modulating or regulating the amount of gas supplied to a welding application. The valve 230 may be opened, closed, or otherwise operated by the controller 212 to enable, inhibit, or control gas flow (e.g., shielding gas) through the valve 230. Shielding gas exits the valve 230 and flows through a gas line 232 (which in some implementations may be packaged with the welding power output) to the wire feeder which provides the shielding gas to the welding application. In some examples, the welding-type power supply 110 does not include the gas supply 228, the valve 230, and/or the gas line 232.

The example robot controller 112 of FIG. 2 includes processor(s) 234, memory 236, one or more storage device(s) 238, power circuitry 240, communications circuitry 242, and one or more I/O device(s) 244.

The example processor(s) 234 execute instructions to configure and/or program a robotic welding procedure, and/or generates commands to execute a robotic welding procedure via the robotic manipulator 106. The processor(s) 234 may include one or more microprocessors, such as one or more “general-purpose” microprocessors, one or more special-purpose microprocessors and/or ASICS, and/or any other type of processing device. For example, the processor(s) 234 may include one or more digital signal processors (DSPs). The memory device 236 may include a volatile memory, such as random access memory (RAM), and/or a nonvolatile memory, such as read-only memory (ROM). The memory device 236 and/or the storage device(s) 238 may store a variety of information and may be used for various purposes. For example, the memory device 236 and/or the storage device(s) 238 may store processor executable instructions (e.g., firmware or software) for the processor(s) 234 to execute. In addition, one or more control regimes for various robotic manipulators and/or robotic welding procedures, along with associated settings and parameters, may be stored in the storage device(s) 238 and/or memory device 236. The storage device(s) 238 (e.g., nonvolatile storage) may include ROM, flash memory, a hard drive, and/or any other suitable optical, magnetic, and/or solid-state storage medium, and/or a combination thereof. The storage device(s) 238 store data (e.g., data corresponding to a welding application), instructions (e.g., software or firmware to perform welding processes), and/or any other appropriate data.

The power circuitry 240 converts input power to power usable by the robot controller 112 (e.g., by the processor(s) 234, the memory 236, the storage device(s) 238, communications circuitry 242, the I/O device(s) 244, and/or the robotic manipulator 106). In the illustrated example, the power supply 110 includes auxiliary power output circuitry 246, which converts input power (e.g., output power from the power conversion circuitry 210, primary power 208) to auxiliary power, such as a standard AC output (e.g., 120 VAC or 240 VAC at 50 Hz or 60 Hz). In some examples, the robot controller 112 may be plugged into welding-type power supply 110 to provide operational power to the robot controller 112 and/or the robotic manipulator 106. In such examples, the robot controller 112 can be plugged into the power supply 110 instead of mains power, and receives the auxiliary power via an auxiliary power connection (e.g., auxiliary power conductors such as an AC power cord).

The example communications circuitry 218 and the communications circuitry 242 of FIG. 2 are configured to communicate via a hard wired connection 248. In examples in which the communications circuitry 218 and the communications circuitry 242 communicate via auxiliary power conductors, the communications circuitry 218 and the communications circuitry 242 may be configured to comply with the IEEE Standard 1901-2010 and/or any other power line communication standard or technique compatible with high-speed communication over the auxiliary power connection.

The I/O device(s) 244 may include operator or user interfaces and/or other data interfaces. Example I/O device(s) 244 may include a keyboard, a keypad, a mouse, a trackball, a pointing device, a microphone, an audio speaker, a display device, an optical media drive, a multi-touch touch screen, a gesture recognition interface, a magnetic media drive, and/or any other operator interface devices to enable an operator to view information about the robot controller 112, the robotic manipulator 106, a robotic welding procedure, the connected power supply 110 and/or any other connected welding equipment, and/or any other information. For example, the I/O device(s) 244 may include input and/or output device(s) to control movement of the robotic manipulator 106. In other examples, the communications circuitry 242 may also include a communication interface to communicate with and control the robotic manipulator 106.

Upon establishing communication between the robot controller 112 and the power supply 110, the power supply 110 may transmit to the robot controller 112 information that can be used to configure the power supply 110. The robot controller 112 can then provide commands to the power supply 110 to configure the power supply 110 to perform the desired welding processes as part of a robotic welding procedure.

Example information that may be automatically transmitted to the robot controller 112 by the power supply 110 may include an: identifier of a paired welding-type power supply (e.g., a serial number, an assigned name, etc.), an identification of capabilities of a paired welding-type power supply (e.g., a listing of features and/or modifiable parameters, a model number, etc.), software instructions to facilitate control of the welding-type power supply 110 by the robot controller 112 (e.g., a software application or plug-in, software updates, software routines, an API, etc.), identification of a welding capability of the welding-type power supply (e.g., a listing of available welding processes), identification of an adjustable parameter of the welding-type power supply (e.g., parameters that are typically used by an operator, parameters that are modifiable by typically hidden from the operator, robotic welding-specific parameters, etc.) identification of a parameter limitation of the welding-type power supply (e.g., voltage limits, current limits, power limits, wire feed speed limits, frequency limits, etc.), a robotic welding procedure and/or welding-type parameters to perform the robotic welding procedure (e.g., a stored, predefined set of instructions to be implemented by the robot controller 112 to perform a robotic welding procedure), and/or any other information that may be transferred between the power supply 110 and the robot controller 112. Additionally or alternatively, the welding-type power supply 110 may transmit one or more available real-time process data streams, such as welding current measurements, output voltage measurements, wire feed speed measurements. The robot controller 112 may use real-time process data streams for other aspects of the robotic welding procedure, such as process control, seam tracking, and/or any other control.

Additionally or alternatively, the welding-type power supply 110 may transmit information about physical system needs, such as the need for physical isolation or other physical configuration to be performed by the operator, to the robot controller 112. Based on the physical configuration information, the robot controller 112 may display the physical information to an operator via a display or otherwise notify the operator of the physical requirements. Additionally or alternatively, the welding-type power supply 110 may transmit system status information about one or more components of the welding system, for display by the robot controller 112 or other action. Example welding equipment system status information may include internal temperature measurements, airflow measurements, coolant circulation information, error codes and/or other diagnostic information, and/or any other status information.

In some examples, the welding-type power supply 110 and/or the robot controller 112 may store information about the most recent system to which the power supply 110 or the robot controller 112 was pairing or connected. This information can then be used to quickly configure a subsequent robot control system to which the power supply 110 is paired or connected, or a subsequent power supply to which the robot controller 112 is paired or connected. For example, an operator may wish to move a power supply 110 from robot station to robot station within a fabrication shop, and have the applicable robot configuration parameters be applied to each robot that is connected or paired to the power supply 110. When the power supply 110 is paired or connected to each subsequent robot control system, the power supply 110 may automatically, or in response to operator input, transmit the robot configuration information to the robot control system to quickly configure the robot control system to perform robotic welding procedures.

In some examples, the welding-type power supply 110 and/or the robot controller 112 automatically update stored robotic welding procedures when changes are made to a stored robotic welding procedure that is imported for use. Additionally or alternatively, the welding-type power supply 110 and/or the robot controller 112 may maintain and store update histories of robotic welding procedures and/or parameters. When an operator makes a change to a robotic welding procedure stored on a power supply 110 (or robot controller 112), and then pairs the power supply 110 (or robot controller 112) to a different robot control system (or different power supply), the previous changes to the robotic welding procedure are automatically recognized and applied, and/or are easily applied and/or easily reverted via a user interface.

The example power supply 110 further includes touch sensing circuitry 254 coupled to the output of the power conversion circuitry 210. The touch sensing circuitry 254 detects, for example, contact between welding-type electrode, which is coupled to a first terminal of the welding-type output, and the workpiece, which is coupled to a second terminal of the welding-type output. For example, the controller 212 may control the touch sensing circuitry 254 to output a low-voltage signal and/or low-current signal to the weld cable 226. The power output by the touch sensing circuitry 254 is insufficient to establish or sustain an arc. The touch sensing circuitry 254 monitors the current and/or voltage outputs of the touch sensing circuitry 254 to detect a short circuit (e.g., via conduction of current and/or via a drop in voltage below a threshold). When a short circuit is detected via the touch sensing circuitry 254, the touch sensing circuitry 254 provides a signal indicating the contact detection to the controller 212 and/or the robot controller 112.

While the example touch sensing circuitry 254 is implemented in the power supply 110, in other examples the touch sensing circuitry 254 may be implemented using the power conversion circuitry 210 or using a separate housing coupled to the power supply 110 and/or to the welding torch 108.

In response to detecting the contact, the example robot controller 112 (e.g., via the processor(s) 234) determines the location of the torch 108 (e.g., the position of the tool center point (TCP)) as a position of the workpiece in the direction being searched. As described in more detail below, the robot controller 112 may use the touch sensing circuitry 254 to perform touch-based searching of the position(s) of a weld seam and/or other features of the workpiece 114.

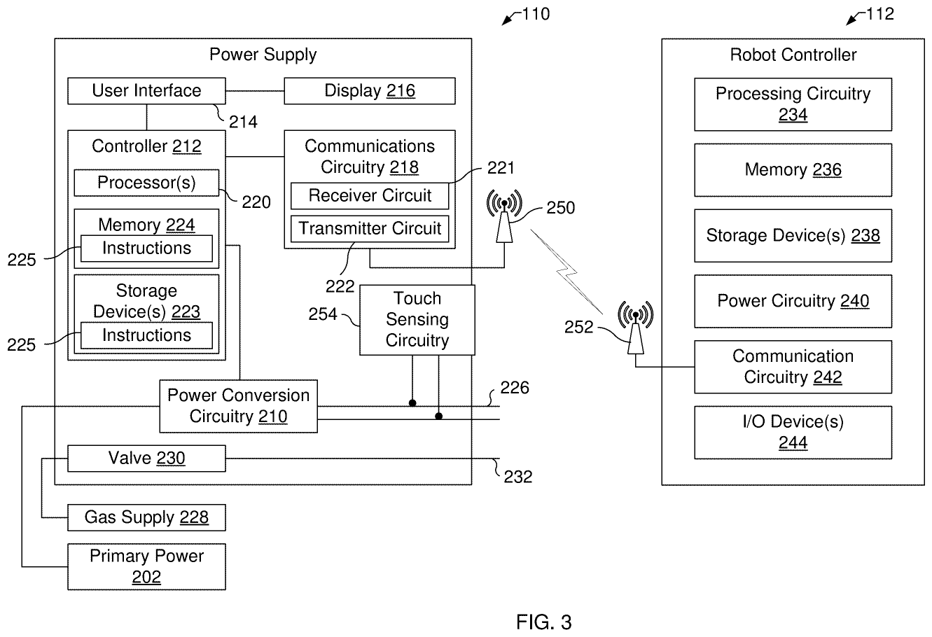

FIG. 3 is a block diagram of another example implementation of the welding-type power supply 110 and the robot controller 112 of FIG. 1. The example power supply 110 of FIG. 3 includes the components of the example power supply 110 of FIG. 2, but may include or omit the auxiliary power output circuitry 246. The example robot controller 112 of FIG. 3 includes the components of the robot controller 112 of FIG. 2.

In contrast with the power line communication of FIG. 2, the example welding-type power supply 110 and the robot controller 112 of FIG. 3 communicate via wireless communications. To this end, the example communications circuitry 218 and communications circuitry 242 are connected to respective antennas 250, 252.

While establishment of communications may occur automatically using power line communications as in FIG. 2, the example robot controller 112 and/or the power supply 110 may require initiation of pairing by the operator (e.g., via the user interface 214 and the I/O device(s) 244) to establish communication between the robot controller 112 and/or the power supply 110. For example, the operator may select a “Pair” button on each of the user interface 214 of the power supply 110 and a user interface of the robot controller 112, which then causes the communications circuitry 218 and the communications circuitry 242 to perform a pairing procedure. Upon establishing the communications channel via pairing, the power supply 110 and the robot controller 112 automatically exchange information and/or configure the power supply 110 as discussed above. In some examples, the operator may further be prompted to verify the pairing occurred between the desired power supply 110 and robot controller 112 (e.g., neither the power supply 110 nor the robot controller 112 paired with an unintended device nearby).

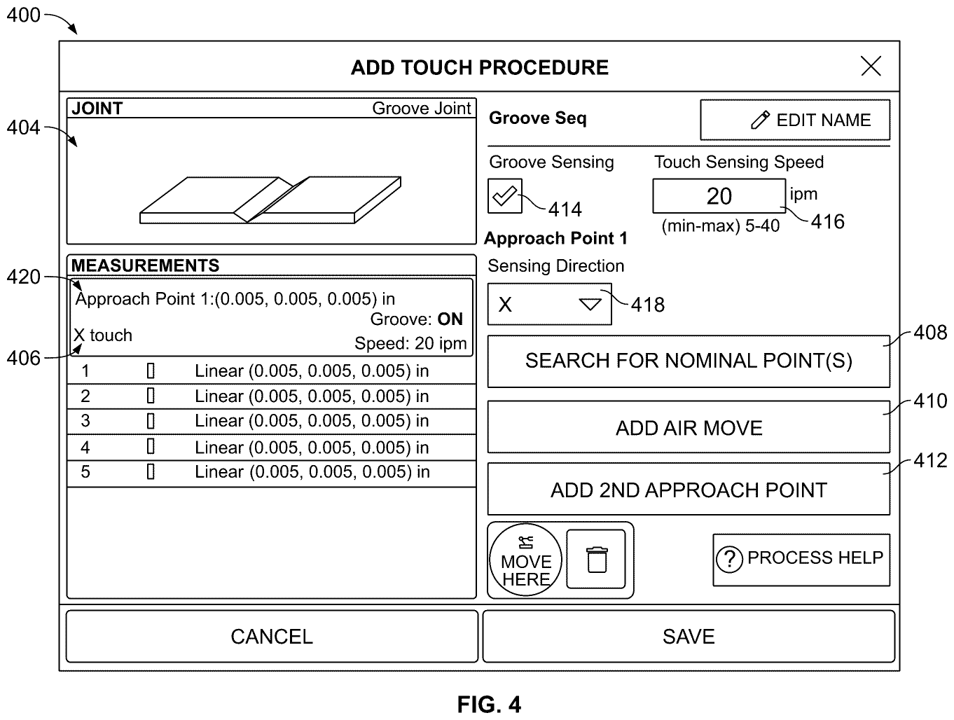

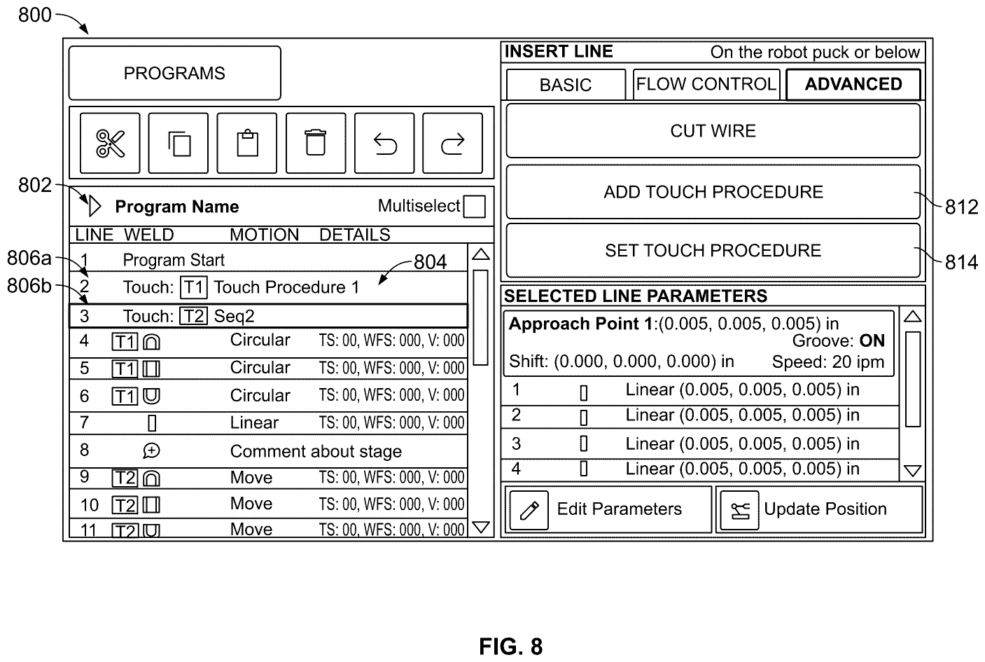

FIG. 4 illustrates an operator interface 400 which may be used to generate instructions to perform robotic welding path correction. The example operator interface 400 may be implemented by the user interface 214 and the display 216, and/or the I/O devices 244, of FIGS. 2 and/or 3. In some examples, the operator interface 400 is implemented to be operated using a touchscreen device and/or operated using a display and one or more input devices. The example interface 400 may be presented in response to an operator selecting a robotic welding path correction option in a weld programming interface (e.g., the interface 800 illustrated in FIG. 8, described below).

The example interface 400 of FIG. 4 includes a search parameter selection window 402, a joint representation graphic 404, and a measurements window 406. The interface 400 further includes command inputs 408-412, including a search command input 408, a non-welding move command input 410, and an additional approach point input 412.

The search parameter selection window 402 includes inputs to allow an operator to specify the type of joint, which may affect the type of weld seam searching that is performed. For example, the operator may input whether the joint is a groove joint via a groove joint selection input 414. The joint representation graphic 404 may be updated based on the groove joint selection input 414. In other examples, other types of inputs may be used to select the type of joint, and/or other types of joints may be included for selection.

The search parameter selection window 402 further includes a touch sensing speed input 416, which may define a speed at which the robot controller 112 controls the robot manipulator 106 to move the welding torch 108 while performing a touch sensing search.

The example search parameter selection window 402 further includes a sensing direction input 418. The operator may specify the direction (e.g., X-axis, Y-axis, Z-axis, positive or negative direction) in which the robot controller 112 is to control the robot manipulator 106 to move the welding torch 108 from the defined approach point while performing the touch sensing search. For example, if the weld seam of a groove joint is nominally oriented in the Y-axis direction (e.g., according to the weld program), the touch-sensing search procedure may measure the location of the groove joint root in the X-axis direction.

The measurements window 406 includes an indication 420 of the position of a selected approach point (e.g., in Cartesian coordinates, within a predetermined frame of reference). For example, the operator may establish the approach point by using a lead-through mode of the robotic manipulator 106 that allows the operator to manually position and orient the welding-type torch 108 and the robotic manipulator 106 at a desired position and/or orientation, which is determined by the robot controller 112 based on position sensors in the robotic manipulator 106. An approach point is the starting location of a touch-sensing search procedure. The operator moves the robotic manipulator 106 to an approach point (e.g., an inch or two from the part), and the robot controller 112 records the location. As used herein, moving the welding torch to a location refers to moving a predetermined point on, or with reference to, the welding torch, such as the TCP of the welding torch.

In some examples, a touch-sensing search procedure can have up to two approach points depending on the type of joint. For example, a groove joint may have a single approach point to detect the location of the groove root, while a non-groove joint may have two approach points to detect the locations of the weld seam and/or location(s) of other surfaces which may affect the length, the starting point, and/or the stopping point of the weld seam.

The operator may generate a position correction instruction by selecting the search command input 408 when the welding torch 108 is positioned at the desired approach point, and the joint type, touch sensing speed, and touch sensing direction have been selected. In response to the search command input 408, the example robot controller 112 generates the position correction instruction, which may include moving the welding torch 108 to the approach point, performing one or more motions with the robotic manipulator 106, controlling the touch sensing circuitry 254 to generate signals on detection of contact, and performing measurements of the position of the torch 108 at the detected contacts.

The position correction instruction is included in a welding program in a sequence with the robotic welding instructions to be performed. In response to reaching the position correction instruction in the sequence, the robot controller 112 automatically controls the robotic manipulator 106 to move the torch 108 to detect positions of one or more surfaces associated with the weld seam (e.g., workpiece surfaces defining the weld seam). Based on the detected positions of the one or more surfaces associated with the weld seam, the robot controller 112 applies correction(s) to positions of the welding instructions that are associated with the position correction instruction.

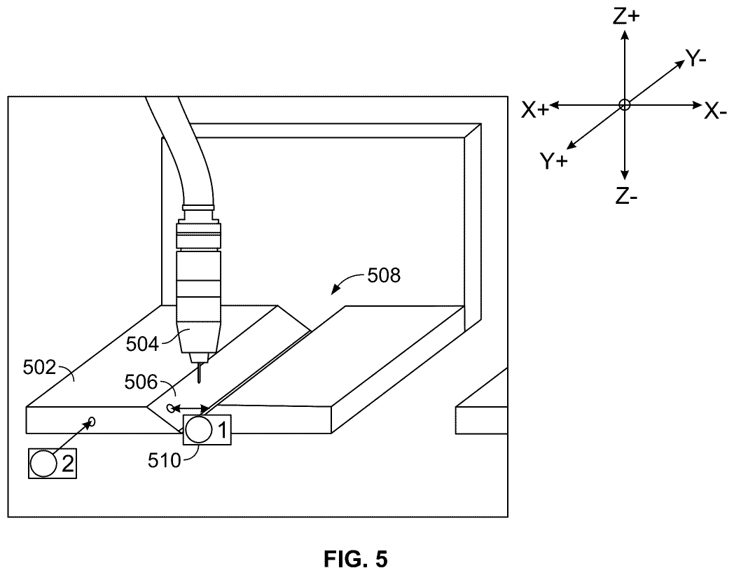

FIG. 5 illustrates an example workpiece 502 and welding torch 504 held by the robotic manipulator 106 of FIG. 1, during a touch-sensing search procedure to perform a position correction instruction. The example of FIG. 5 is performed with a groove joint type selected (e.g., via the groove joint selection input 414).

Based on determining that the weld joint type is a groove joint, the robot controller 112 moves the torch 108 to the a first approach point 512. From the first approach point 512 (e.g., set by lead-through teaching), the example robot controller 112 automatically controls the robotic manipulator 106 to move the torch 504 in the −Z direction (e.g., downward toward the groove joint) until contact is detected via the touch sensing circuitry 254. Generally, the contacted point would be a beveled edge 506 of the groove joint 508. The robot controller 112 then controls the robotic manipulator 106 to move the torch 504 in the +X or −X direction to detect an opposing beveled edge of the groove joint 508.

The robot controller 112 may determine a midpoint, in the searched direction, between the two recorded locations of the edges of the groove joint 508 to determine a position of the groove root in the searched direction. In some examples, the robot controller 112 controls the robotic manipulator 106 to move the torch 108 to the determined position of the groove root 510, and then controls the robotic manipulator 106 to move the torch 504 in the Z-direction to determine a location (e.g., depth) of the groove root 510.

In some examples, the operator may further specify searching in the Y direction using a second approach point 512. The example interface 400 includes an additional approach point input 412 to allow the operator to set the second approach point and additional approach points, where desired. After adding an approach point, the operator may select the search command input 408 to generate additional touch-sensing search instructions based on the second approach point, the joint type, the searching direction, and/or the searching speed. To perform the additional searching, the touch-sensing search procedure is further generated to involve moving the torch 504 to the second approach point 512 (e.g., defined via the interface 400 using the positioning of the welding torch 504 at the time of selection of the additional approach point input 412), and controlling the robotic manipulator 106 to move the torch 504 in the specified search direction.

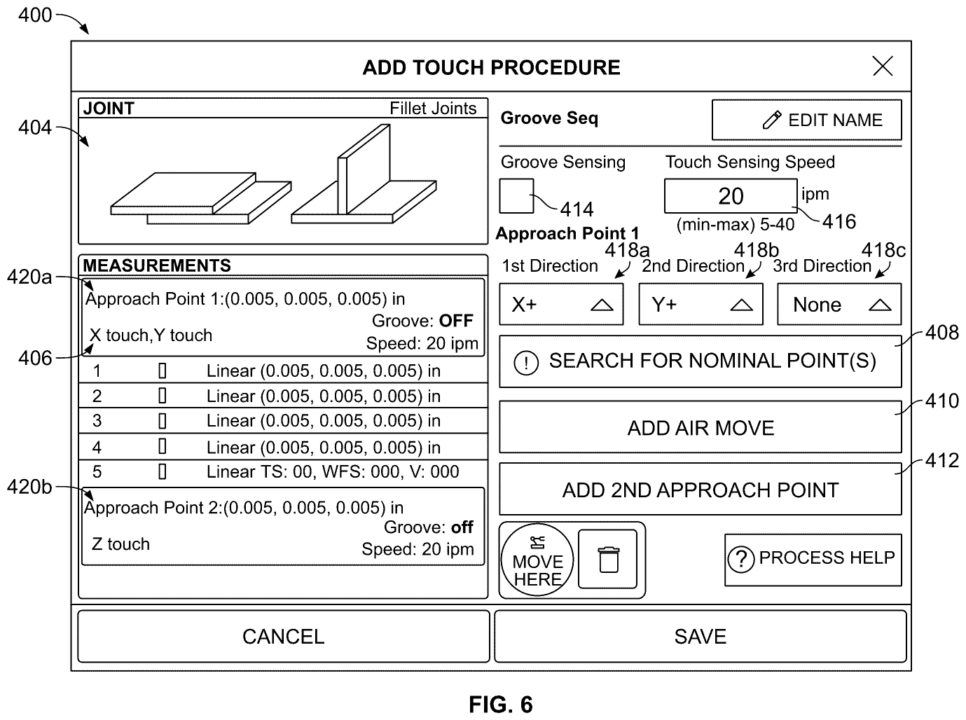

FIG. 6 illustrates the example user interface 400 of FIG. 4, in which a non-groove type of joint is selected via the groove joint selection input 414. In the example of FIG. 6, the search parameter selection window 402 permits selection of multiple search directions via multiple sensing direction inputs 418a, 418b, 418c. The selected search directions may be performed in a specified order (e.g., indicated by the sensing direction inputs 418a, 418b, 418c). The example of FIG. 6 further illustrates multiple defined approach points 420a, 420b.

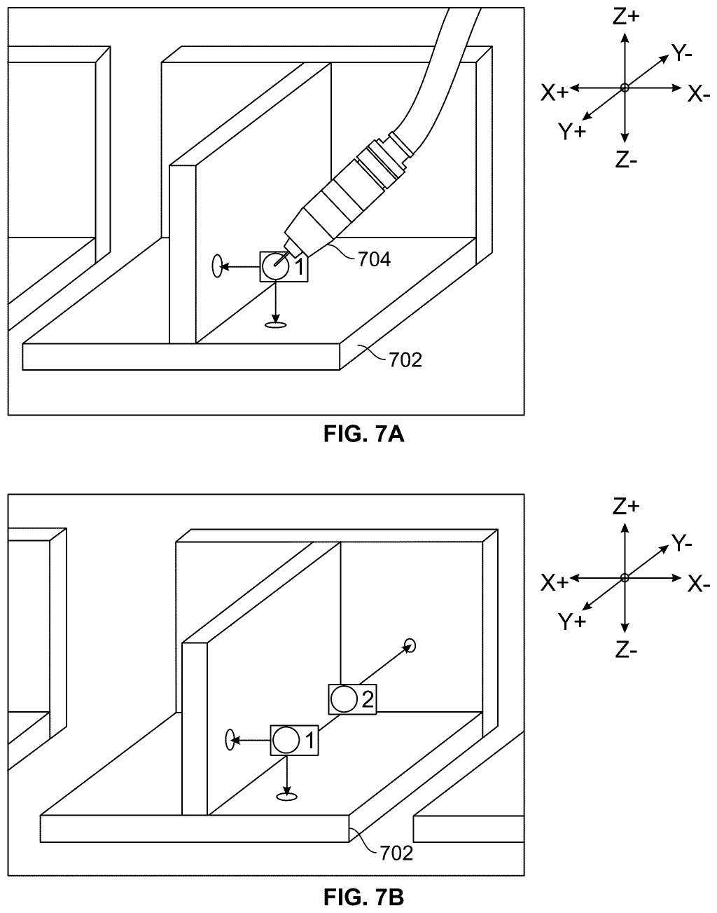

FIGS. 7A and 7B illustrates another example workpiece 702 and welding torch 704 held by the robotic manipulator 106 of FIG. 1, during a touch-sensing search procedure to perform a position correction instruction. The examples of FIGS. 7A and 7B are performed with a non-groove joint type selected (e.g., via the groove joint selection input 414).

In the example of FIG. 7A, a first approach point 706 is defined, from which the welding torch 704 is moved in the +X direction to detect a first surface position. The welding torch 704 is also moved from the approach point 706 in the −Z direction to detect a second surface position. The position of the weld seam may be determined based on the first and second surface positions.

Similarly, in the example of FIG. 7B, the first approach point 706, the first search direction (e.g., +X), and the second search direction (e.g., −Z) are defined. A second approach point 708 and a third search direction (e.g., +Y) are also defined to determine the position of another surface, such as a potential collision hazard or other obstacle. The position of the first approach point 706, the first search direction (e.g., +X), and the second search direction (e.g., −Z), and the second approach point 708 and the third search direction (e.g., +Y) are defined in a corresponding position correction instruction. The detected positions (e.g., relative to a reference position, such as the approach points 706, 708) are stored upon performance of the touch-sensing search procedures, for applying a positional offset to welding instructions that are associated with the position correction instruction in the welding program.

FIG. 8 illustrates another example operator interface 800 which may be used to associate robotic welding instructions with position correction instructions. The example operator interface 800 may be implemented by the user interface 214 and the display 216, and/or the I/O devices 244, of FIGS. 2 and/or 3. In some examples, the operator interface 800 is implemented to be operated using a touchscreen device and/or operated using a display and one or more input devices.

The example interface 800 of FIG. 8 includes a program sequence window 802, a procedure detail window 804, and a touch-sensing search procedure selection input 806. The example interface 800 may include additional or alternative inputs and/or information.

The example program sequence window 802 displays a sequence of weld instructions for a selected welding program that may be performed using the robotic welding system 100 of FIG. 1. The example weld instructions may include instructions to begin a weld, move during a welding process, end a weld, perform a non-welding movement, and/or any other instructions to control operation of the robotic manipulator 106 and/or the welding power supply 110.

The example sequence of weld instructions includes first and second position correction instructions 806a, 806b. Each of the first and second position correction instructions 806a, 806b is associated with one or more welding instructions. For example, the first position correction instruction 806a is associated with a first set of welding instructions 808 which, in combination, instruct the robotic welding system 100 to perform a first weld. Similarly, the second position correction instruction 806b is associated with a second set of welding instructions 810 which, in combination, instruct the robotic welding system 100 to perform a second weld.

The example interface 800 includes a position correction instruction generation input 812 that allows an operator to enter a second interface to generate or define position correction instruction. For example, selecting the position correction instruction generation input 812 may cause the operator interface 102 to display the interface 400 of FIG. 4.

The example interface 800 may allow an operator to associate the first and/or second position correction instructions 806a, 806b with selected ones of the welding instructions. In some examples, a position correction association input 814 allows an operator to associate selected welding instructions (e.g., in the program sequence window 802) with a selected position correction instruction. Additionally or alternatively, welding instructions may be selected for association at the time the position correction instruction generation input 812 is received, such that the welding instructions are automatically associated with the position correction instruction when the position correction instruction is generated.

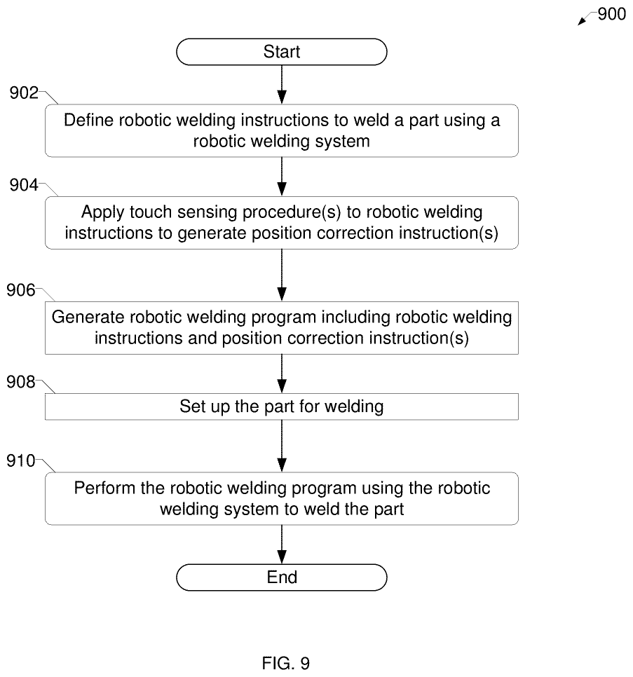

FIG. 9 is a flowchart representative of example method 900 which may be performed by the example robotic welding system 100 of FIG. 1 to perform a robotic welding procedure with welding path correction. The example method 900 may be performed by components of the power supply 110, the robot controller 112, and/or any other components of the system 100.

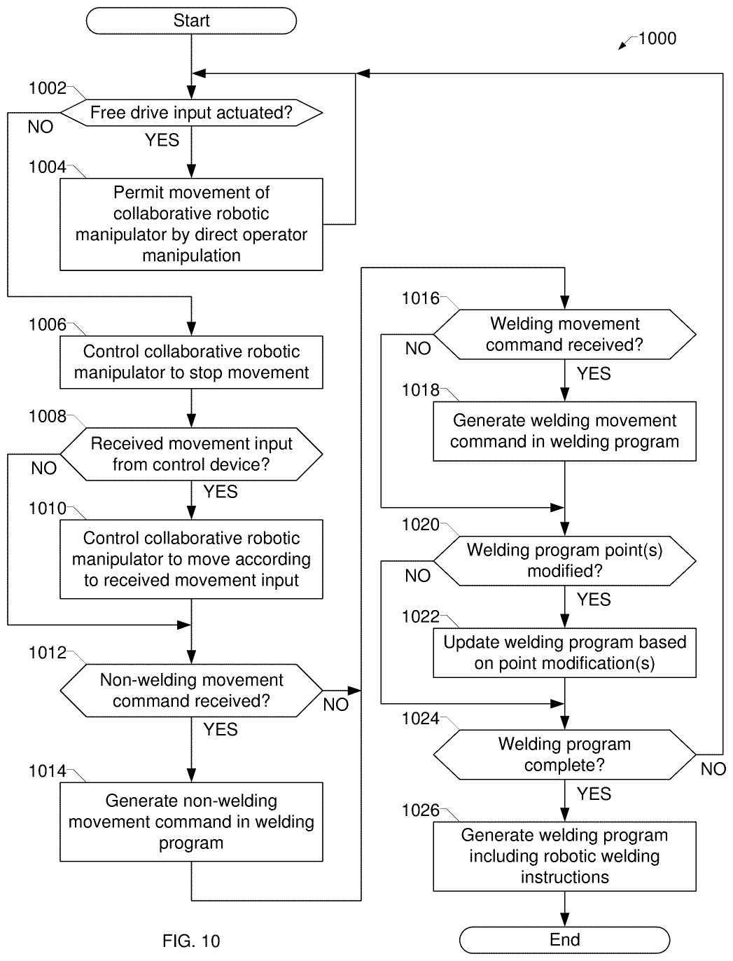

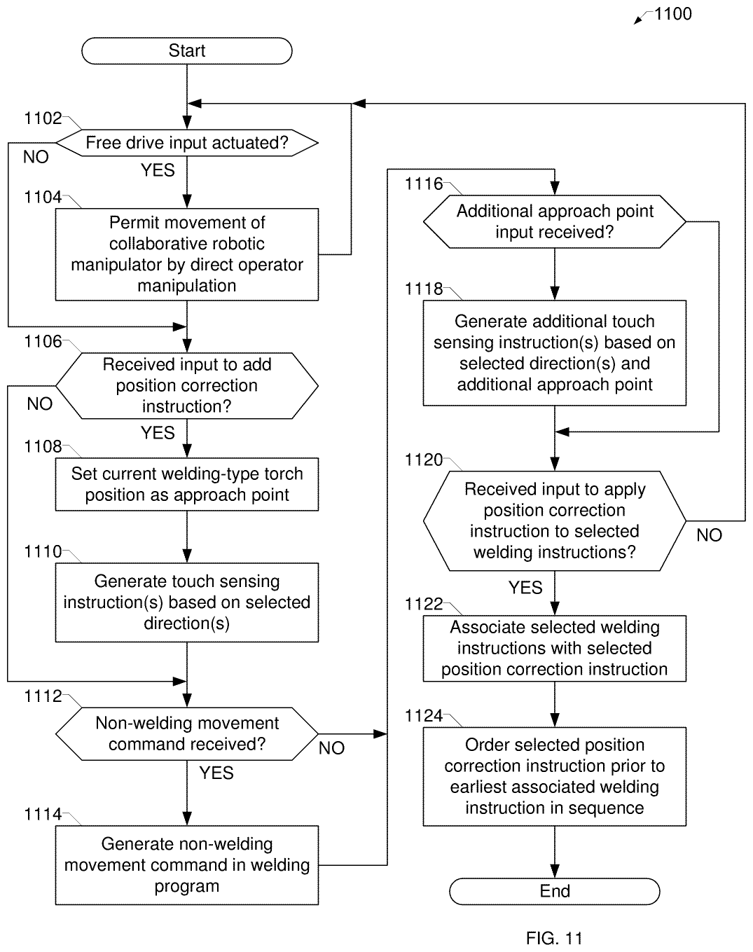

At block 902, the robot controller 112 defines robotic welding instructions to weld a type of part using the robotic welding system 100 (e.g., the robotic manipulator 106, the welding torch 108). For example, an operator may use lead-through teaching in combination with the user interface to generate a robotic welding program to weld a part. The teaching may involve, for example, lead-through teaching, stylus-based teaching, joystick-based teaching, pendant-based teaching, and/or any other type or combination of types of teaching welding program points and/or commands. The robot controller 112 stores location information, commands, and/or any other instructions based on the teach points as set by an operator. Example instructions that may be used to perform block 902 are disclosed below with reference to FIG. 10.

At block 904, the robot controller 112 applies touch sensing procedure(s) to the robotic welding instructions to generate position correction instructions. For example, the operator may generate and associate welding instructions associated with one or more welds to respective ones of the position correction instructions (e.g., touch-sensing search procedures) using the interface 800 of FIG. 8. Example instructions that may be used to perform block 904 are disclosed below with reference to FIG. 11.

At block 906, the robot controller 112 generates a robotic welding program including the robotic welding instructions and the position correction instructions. For example, the robot controller 112 may order the position correction instructions in the sequence of the welding program such that the touch-sensing search procedure of a position correction instruction is performed prior to welding instructions which are associated with that position correction instruction.

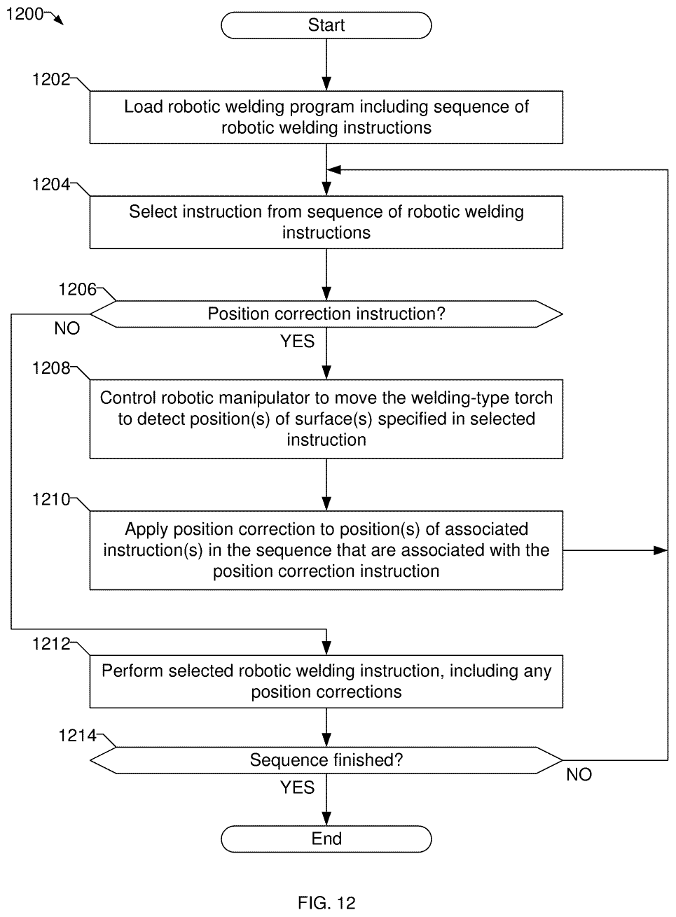

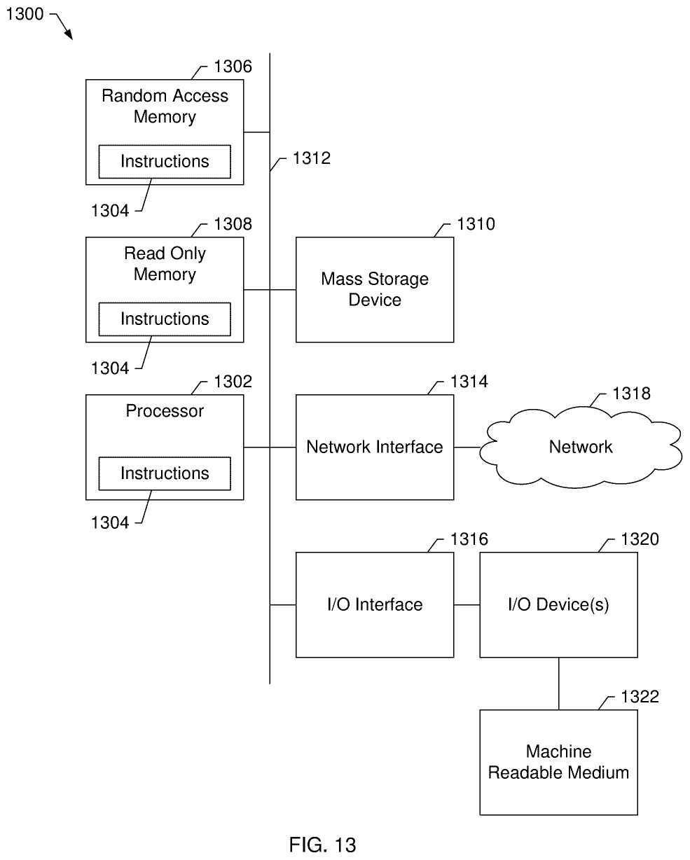

At block 908, the type of part is set up for welding (e.g., by an operator on the table 154). At block 910, the robotic welding system 100 performs the robotic welding program to weld the type of part. Blocks 908 and 910 may be repeated for multiple parts. Example instructions to implement block 910 are described below with reference to FIG. 12. The example method 900 then ends.

FIG. 10 is a flowchart representative of example machine readable instructions 1000 which may be executed by the example robot controller 112 to generate a robotic welding program. The example instructions 1000 may be performed to implement block 902 of FIG. 5.

At block 1002, the robot controller 112 determines whether a free drive input is actuated. For example, the operator may actuate a switch to place the robotic manipulator 106 into a free drive mode, in which the operator can physically manipulate the position and orientation of the robotic manipulator. If the free drive input is actuated (block 1002), at block 1004 the robot controller 112 permits movement of the robotic manipulator 106 by direct operator manipulation. For example, the robot controller 112 may control the robotic manipulator 106 to apply sufficient force to overcome gravitational forces, but to otherwise allow the operator to manipulate the robotic manipulator 106. Control then returns to block 1002.

If the free drive input is not actuated (block 1002), at block 1006 the robot controller 112 controls the robotic manipulator 106 to stop movement (e.g., to lock). For example, the robot controller 112 may control the robotic manipulator 106 to apply sufficient force to substantially prevent physical manipulation by the operator.

At block 1008, the robot controller 112 determines whether a movement input has been received from a control device. Example control devices may include a joystick, a stylus, a pendant, and/or any other type of motion control input device. If a movement input has been received from a control device (block 1008), at block 1010 the robot controller 112 controls the robotic manipulator 106 to move according to the received movement input. Control then returns to block 1008.

If a movement input has not been received from a control device (block 1008), at block 1012 the robot controller 112 determines whether a non-welding movement command has been received. An example non-welding movement command may be a non-welding jog movement (e.g., moving to the start of a weld, moving between welds, etc.) or a command to end a welding movement. If a non-welding movement command has been received (block 1012), at block 1014 the robot controller 112 generates a non-welding movement command in the welding program, including a kinematic solution to implement the movement command. For example, the robot controller 112 may calculate and store instructions for joint actuators to implement the movement command.

If a non-welding movement command has not been received (block 1012), or after generating a non-welding movement command (block 1014), at block 1016 the robot controller 112 determines whether a welding movement command has been received. Example welding movement commands may include starting a weld at a particular location and/or for specifying a position of an ongoing weld (e.g., for curvature calculation, for changing linear directions, etc.). If a welding movement command has been received (block 1016), at block 1018 the robot controller 112 generates a welding movement command in the welding program, including a kinematic solution to implement the movement command.

If a welding movement command has not been received (block 1016), or after generating a welding movement command (block 1018), at block 1020 the robot controller 112 determines whether any welding program point(s) have been modified. For example, the robot controller 112 may determine whether the operator has marked a movement point near a previously existing movement point and/or modified the program point(s) via a pendant or other control device. If welding program point(s) have been modified (block 1020), at block 1022 the robot controller 112 update the welding program based on the point modification(s).

If welding program point(s) have not been modified (block 1020), or after updating the welding program based on the point modification(s) (block 1022), at block 1024 the robot controller 112 determines whether the welding program is complete. For example, the operator may indicate via a user interface that the welding program is finished and/or the welding instructions should be generated (if not done in real-time as the teaching is occurring). If the welding program is not complete (block 1024), control returns to block 1002 to continue teaching.

If the welding program is complete (block 1024), at block 1026 the robot controller 112 generates the robotic welding program including the robotic welding instructions. For example, the robot controller 112 may convert the program points to assembly instructions or other computer code, commands, kinematic solutions, and/or other data used to implement the robotic welding program. The example instructions 1000 may then end, and return control to block 904 of FIG. 9.

In some examples, block 1026 is performed during the creation of movement points and/or commands (e.g., blocks 1002-1022) rather than as a batch when the welding program is performed.

FIG. 11 is a flowchart representative of example machine readable instructions 1100 which may be performed to implement the robot controller 112 of FIGS. 1, 2, and/or 3 to apply touch sensing procedure(s) to robotic welding instructions to generate position correction instruction(s). The example instructions 1100 may be performed to implement block 904 of FIG. 9.

At block 1102, the robot controller 112 determines whether a free drive input is actuated. For example, the operator may actuate a switch to place the robotic manipulator 106 into a free drive mode, in which the operator can physically manipulate the position and orientation of the robotic manipulator. If the free drive input is actuated (block 1102), at block 1104 the robot controller 112 permits movement of the robotic manipulator 106 by direct operator manipulation. For example, the robot controller 112 may control the robotic manipulator 106 to apply sufficient force to overcome gravitational forces, but to otherwise allow the operator to manipulate the robotic manipulator 106. Control then returns to block 1102.

At block 1106, the robot controller 112 determines whether an input has been received to add a position correction instruction. For example, the interface 400 of FIGS. 4 and 6 may allow the operator to select the search command input 408 to generate a command to perform a position correction involving a touch-sensing search procedure. If an input has been received to add a position correction instruction (block 1106), at block 1108 the robot controller 112 sets a current position of the welding torch 108 as an approach point (e.g., the approach point 512 of FIG. 5, the approach points of FIGS. 7A and/or 7B). At block 1110, the robot controller 112 generates touch sensing instruction(s) based on the selected search direction(s). For example, search directions may be specified via the sensing direction input 418. The touch sensing instruction(s) may provide instructions to the robot controller 112 to detect one or more surface(s), weld seams, and/or other aspects of the workpiece.

After generating the touch sensing instruction(s) (block 1110), or if the input has not been received to add a position correction instruction (block 1106), at block 1112 the robot controller 112 determines whether a non-welding movement command has been received. An example non-welding movement command may be a non-welding jog movement (e.g., moving to the start of a weld, moving between welds, etc.) or a command to end a welding movement. If a non-welding movement command has been received (block 1112), at block 1114 the robot controller 112 generates a non-welding movement command in the welding program, including a kinematic solution to implement the movement command. For example, the robot controller 112 may calculate and store instructions for joint actuators to implement the movement command.

If a non-welding movement command has not been received (block 1112), or after generating a non-welding movement command (block 1114), at block 1116 the robot controller 112 determines whether an additional approach point input has been received. For example, the operator may select the additional approach point input 412 to allow the operator to set the second approach point and additional approach points. If the additional approach point input has been received (block 1116), at block 1118 the robot controller 112 generates additional touch sensing instruction(s) based on the selected direction(s) and the additional approach point. For example, the robot controller 112 may generate instructions to perform an additional touch sensing procedure (e.g., a second approach point as shown in FIGS. 5 and/or 7B). The additional touch sensing procedure may be similar to a first touch sensing procedure, but defined with different directions and approach point, which is specified as part of a same position correction instruction.

After generating the additional touch sensing instructions (block 1118), or if an additional approach point input is not received (block 1116), at block 1120 the robot controller 112 determines whether an input has been received to apply the position correction instruction to selected welding instructions. For example, the interfaces 400 and/or 800 may include an input (e.g., position correction association input 814) to associate selected welding instructions with a selected position correction instruction. Additionally or alternatively, welding instructions may be selected for association at the time the position correction instruction generation input 812 is received, such that the welding instructions are automatically associated with the position correction instruction when the position correction instruction is generated.

If the input to apply the position correction instruction to selected welding instructions has been received (block 1120), at block 1122 the robot controller 112 associates selected welding instructions with selected position correction instruction. For example, a first weld including first welding instructions is associated with a first position correction instruction 806a in FIG. 8, and a second weld including second welding instructions is associated with a second position correction instruction 806b. At block 1124, the robot controller 112 orders the selected position correction instruction prior to the earliest associated welding instruction in the sequence of welding instructions in the welding program. In some examples, the position correction instructions are ordered first in the sequence, but may be ordered later in the sequence (but prior to associated welding instructions) to reduce the non-welding movements of the welding program and improve the efficiency of the welding program.

The example instructions 1100 then end.

FIG. 12 is a flowchart representative of example machine readable instructions 1200 which may be performed to implement the robot controller 112 of FIGS. 1, 2, and/or 3 to perform a robotic welding program using the robotic welding system 100 to weld a part. The example instructions 1200 may be performed to implement block 910 of FIG. 9.

At block 1202, the robot controller 112 loads a robotic welding program having a sequence of robotic welding instructions. The robotic welding program may further include one or more position correction instructions. At block 1204, the robot controller 112 selects an instruction from the sequence of robotic welding instructions. For example, the robot controller 112 may select the first instruction for a first instance of block 1204, or a next instruction in the sequence for subsequent instances of block 1204.

At block 1206, the robot controller 112 determines whether the selected instruction is a position correction instruction. If the selected instruction is a position correction instruction (block 1206), at block 1208 the robot controller 112 controls the robotic manipulator 106 to move the welding torch 108 to detect position(s) of surface(s) specified in the selected instruction. For example, the robot controller 112 may use feedback from the touch sensing circuitry 254 and movement of the torch 108 in an X-axis direction, a Y-axis direction, and/or a Z-axis direction to detect the positions of surface(s) in those directions.

At block 1210, the robot controller 112 applies position corrections to position(s) of associated welding instructions in the sequence for welding instructions that are associated with the position correction instruction. For example, the robot controller 112 may store a position offset from a reference position (e.g., the defined approach point) in one or more directions and/or dimensions, and apply the offset to the positions defined for the welding instructions that are associated with the position correction instruction. Control then returns to block 1204.

If the selected instruction is not a position correction instruction (block 1206), at block 1212 the robot controller 112 performs the selected robotic welding instruction, including any position corrections. For example, the robot controller 112 may control the robotic manipulator 106, the welding power supply 110, and/or any other equipment to perform the welding instruction.

At block 1214, the robot controller 112 determines whether the sequence is finished, or if there are additional welding instructions. If the sequence is not finished (block 1214), control returns to block 1204 to select a next instruction. When the sequence is finished (block 1214), the example instructions 1200 end.

The present devices and/or methods may be realized in hardware, software, or a combination of hardware and software. The present methods and/or systems may be realized in a centralized fashion in at least one computing system, processors, and/or other logic circuits, or in a distributed fashion where different elements are spread across several interconnected computing systems, processors, and/or other logic circuits. Any kind of computing system or other apparatus adapted for carrying out the methods described herein is suited. A typical combination of hardware and software may be a processing system integrated into a welding power source with a program or other code that, when being loaded and executed, controls the welding power source such that it carries out the methods described herein. Another typical implementation may comprise an application specific integrated circuit or chip such as field programmable gate arrays (FPGAs), a programmable logic device (PLD) or complex programmable logic device (CPLD), and/or a system-on-a-chip (SoC). Some implementations may comprise a non-transitory machine-readable (e.g., computer readable) medium (e.g., FLASH memory, optical disk, magnetic storage disk, or the like) having stored thereon one or more lines of code executable by a machine, thereby causing the machine to perform processes as described herein. As used herein, the term “non-transitory machine readable medium” is defined to include all types of machine readable storage media and to exclude propagating signals.

An example control circuit implementation may be a microcontroller, a field programmable logic circuit and/or any other control or logic circuit capable of executing instructions that executes weld control software. The control circuit could also be implemented in analog circuits and/or a combination of digital and analog circuitry.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A robotic welding system, comprising:
a welding-type power supply configured to output welding-type power to a welding-type torch;
a robotic manipulator configured to manipulate the welding-type torch; and
robot control circuitry configured to:
load a welding program comprising a sequence of robotic welding instructions, the robotic welding instructions comprising a plurality of positions associated with a welding operation to be performed along a welding seam using the welding-type torch, the sequence further comprising a position correction instruction;
in response to reaching the position correction instruction in the sequence:
automatically control the robotic manipulator to move the welding-type torch to detect positions of one or more surfaces associated with the weld seam; and
based on the detected positions of the one or more surfaces associated with the weld seam, applying a correction to ones of the positions associated with the position correction instruction; and
perform the robotic welding instructions in the sequence based on the plurality of positions and based on the corrections.

2. The robotic welding system as defined in claim 1, further comprising touch detection circuitry coupled to the welding-type torch and configured to detect contact between a welding wire fed via the welding-type torch and a workpiece, wherein the robot control circuity is configured to detect the positions of the one or more surfaces based on the touch detection circuitry detecting the contact between the welding wire and the workpiece.

3. The robotic welding system as defined in claim 1, further comprising a user interface having a display and an input device, the input device configured to receive a type of weld joint from a plurality of types of weld joints, and the robot control circuitry further configured to control the robotic manipulator to move the welding-type torch to detect the positions of the one or more surfaces based on the type of weld joint.

4. The robotic welding system as defined in claim 3, wherein the user interface is configured to receive a user selection of one or more of the predetermined coordinate directions, the robot control circuitry configured to control the robotic manipulator to move the welding-type torch along the selected one or more of the predetermined coordinate directions.

5. The robotic welding system as defined in claim 4, wherein the user interface is configured to limit the predetermined coordinate directions based on the type of weld joint.

6. The robotic welding system as defined in claim 3, wherein the robot control circuitry is further configured to control the robotic manipulator to move the welding-type torch along one or more of a plurality of predetermined coordinate directions to detect the positions of the one or more surfaces.

7. The robotic welding system as defined in claim 3, wherein the position correction instructions comprise an approach point, wherein the robot control circuitry is configured to control the robotic manipulator to move the welding-type torch to the approach point to begin detecting the positions of the one or more surfaces.

8. The robotic welding system as defined in claim 7, the user interface is configured to receive an input to set a position of the approach point.

9. The robotic welding system as defined in claim 3, wherein the robot control circuitry is configured to, based on determining that the weld joint type is a groove joint, control the robotic manipulator to:
move the welding-type torch to an approach point defined by the position correction instruction;
move the welding-type torch in a first predetermined direction;
in response to detecting a first contact between the welding-type torch and the workpiece, store the position of the welding-type torch as a first position and stop movement of the welding-type torch;
move the welding-type torch in a second direction;
in response to detecting a second contact between the welding-type torch and the workpiece, store the position of the welding-type torch as a second position and stop movement of the welding-type torch;
determine a root position along the second direction based on the first position and the second position;
move the welding-type torch in a third predetermined direction, opposite the second predetermined direction, based on the root position; and
move the welding-type torch in the first predetermined direction; and
in response to detecting a third contact between the welding-type torch and the workpiece, store the position of the welding-type torch as a third position and stop movement of the welding-type torch.

10. The robotic welding system as defined in claim 9, wherein the user interface is configured to receive an input to select the second direction.

11. The robotic welding system as defined in claim 1, wherein the robot control circuitry is configured to, in response to determining that the weld joint type is a fillet joint or other non-groove joint, control the robotic manipulator to:
move the welding-type torch to an approach point defined by the position correction instruction;
move the welding-type torch in a first direction;
in response to detecting a first contact between the welding-type torch and the workpiece, store the position of the welding-type torch as a first position and stop movement of the welding-type torch; and
determine a weld seam position based on the first position.

12. The robotic welding system as defined in claim 11, wherein the robot control circuitry is further configured to, in response to determining that the weld joint type is a fillet joint or other non-groove joint, control the robotic manipulator to:
move the welding-type torch in a second direction;
in response to detecting a second contact between the welding-type torch and the workpiece, store the position of the welding-type torch as a second position and stop movement of the welding-type torch; and
determine the weld seam position based on the first position and the second position.

13. The robotic welding system as defined in claim 12, wherein the robot control circuitry is further configured to, in response to determining that the weld joint type is a fillet joint or other non-groove joint, control the robotic manipulator to:
move the welding-type torch in a third direction, different than the first direction and the second direction; and
in response to detecting a third contact between the welding-type torch and the workpiece, store the position of the welding-type torch as a third position and stop movement of the welding-type torch; and
determine the weld seam position based on the first position, the second position, and the third position.

14. The robotic welding system as defined in claim 13, wherein the robot control circuitry is configured to control the robotic manipulator to move to a second approach point prior to moving the welding-type torch in the third direction.

15. The robotic welding system as defined in claim 14, wherein the user interface is configured to receive a position of the second approach point as an input.

16. The robotic welding system as defined in claim 1, wherein the user interface is configured to receive a selection of the first direction and the second direction.

17. The robotic welding system as defined in claim 1, further comprising a user interface having a display and an input device, the robot control circuitry configured to associate the ones of the positions with the position correction instruction and apply the correction based on the associated ones of the positions.
